(19) United States
(12) Patent Application Publication
(10) Pub. No.: US 2015/0301320 A1
(43) Pub. Date: Oct. 22, 2015

(54) PROJECTION LENS AND PROJECTION DEVICE THEREOF

(71) Applicants: Qisda Optronics (Suzhou) Co., Ltd., Suzhou (CN); Qisda Corporation, Taoyuan County (TW)

(72) Inventor: Ming-Kuen Lin, Yunlin County (TW)

(21) Appl. No.: 14/689,054

(22) Filed: Apr. 17, 2015

(30) Foreign Application Priority Data
Apr. 18, 2014 (TW) 103114235

(51) Int. Cl. G02B 15/177; G03B 21/14; G02B 27/00; G02B 13/04; G02B 13/16; G02B 13/18

(52) U.S. Cl. CPC G02B 15/177; G02B 13/16; G02B 13/18; G02B 27/0025; G02B 13/04; G03B 21/142

(57) ABSTRACT

A projection device of projecting an image on a screen is disclosed. A projection lens of the projection device is disposed between the screen and an imaging unit of the projection device, to project light from a light source of the projection device on the screen. The projection lens includes a first lens group and a second lens group. The first lens group adjacent to the screen includes a first lens, a second lens and a third lens having negative diopter. The first lens is an aspheric lens adjacent to the screen. The second lens group adjacent to the imaging unit has positive diopter. An effective focal length of the projection lens represents f, a focal length of the first lends group represents f_{G1}, focal length of the first lens, the second lens and the third lens represents f_{L1}, f_{L2} and f_{L3}, and

$$0.75 \leq \vert {f}_{G 1} \vert / f \leq 1.28 , \vert \frac{1}{{f}_{L 1}} + \frac{1}{{f}_{L 2}} \vert > \vert \frac{1}{{f}_{L 3}} \vert .$$

### BACKGROUND OF THE INVENTION

1. Field of the Invention

The present invention relates to a projection lens and a projection device thereof, and more particularly, to a short throw projection lens and a related projection device having a short throw projection lens.

2. Description of the Prior Art

With the advanced technology, the projection device is utilized to display image information in conferences, and the short throw projection lens becomes popular due to its properties of easy portability and convenient focus adjustment for the narrow council room. The conventional projection lens is expensive and achieves short throw effect by secondary imaging technique, so that design of a short throw projection lens with advantages of lower cost and easy mass production is an important issue in the optical lens industry.

### SUMMARY OF THE INVENTION

The present invention provides a short throw projection lens and a related projection device having a short throw projection lens for solving above drawbacks.

According to the claimed invention, a projection lens includes a first lens group adjacent to an object side, and a second lens group adjacent to an image side. The first lens group includes a first lens, a second lens and a third lens having negative diopter. The first lens is an aspheric lens adjacent to the object side, and the second lens is located between the first lens and the third lens. The second lens group has positive diopter. An effective focal length of the projection lens represents f, a focal length of the first lends group represents f_{G1}, focal length of the first lens, the second lens and the third lens respectively represents f_{L1} f_{L2} and f_{L3}, and

$$0.75 \leq \vert {f}_{G 1} \vert / f \leq 1.28 , \vert \frac{1}{{f}_{L 1}} + \frac{1}{{f}_{L 2}} \vert > \vert \frac{1}{{f}_{L 3}} \vert .$$

According to the claimed invention, a projection device of projecting an image on a screen is disclosed. The projection device includes a light source for emitting light, an imaging unit for receiving the light, and a projection lens disposed between the screen and an imaging unit to project the light on the screen. The projection lens includes a first lens group adjacent to the screen, and a second lens group adjacent to the imaging unit . The first lens group includes a first lens, a second lens and a third lens having negative diopter. The first lens is an aspheric lens adjacent to the object side, and the second lens is located between the first lens and the third lens. The second lens group has positive diopter. An effective focal length of the projection lens represents f, a focal length of the first lends group represents f_{G1}, focal length of the first lens, the second lens and the third lens respectively represents f_{L1}, f_{L2} and f_{L3}, and

$$0.75 \leq \vert {f}_{G 1} \vert / f \leq 1.28 , \vert \frac{1}{{f}_{L 1}} + \frac{1}{{f}_{L 2}} \vert > \vert \frac{1}{{f}_{L 3}} \vert .$$

The present invention designs the non-telecentric projection lens which applies the aspheric lens to be the first lens of the lens group. The present invention utilizes the aspheric lens to correct optical defect such as imaging distortion and chromatic aberration, not only can effectively increase imaging quality of the projection device but also decreases the lens amount of the projection lens to provide advantages of inexpensive cost and easy mass production.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a projection device according to an embodiment of the present invention.

FIG. 2 is a partial diagram of the projection device according to the embodiment of the present invention.

FIG. 3 to FIG. 7 respectively are schematic diagrams of projection lens with different first lens groups according to the embodiment of the present invention.

FIG. 8 is a simulating diagram of ray aberration of the projection lens according to the embodiment of the present invention.

FIG. 9 is a simulating diagram of field curvature and distortion of the projection lens according to the embodiment of the present invention.

FIG. 10 is a simulating diagram of lateral color of the projection lens according to the embodiment of the present invention.

FIG. 11 is a simulating diagram of modulation transfer function of the projection lens 18 according to the embodiment of the present invention.

### DETAILED DESCRIPTION

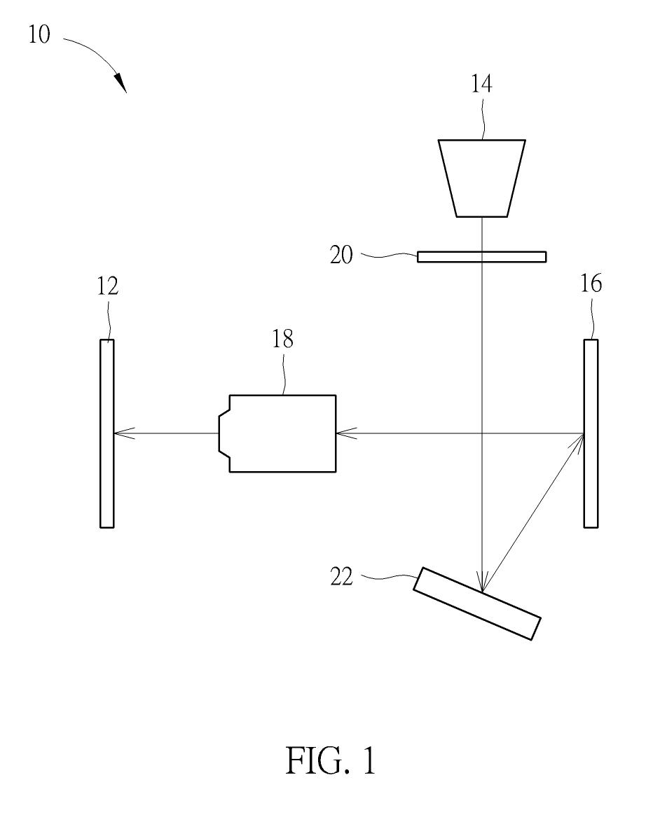

Please refer to FIG. 1. FIG. 1 is a diagram of a projection device 10 according to an embodiment of the present invention. The projection device 10 projecting an image on a screen 12 includes a light source 14, an imaging unit 16, a projection lens 18, a filtering unit 20 and a reflector 22. The light source 14 emits light, the filtering unit 20 receives the light for light filtration, and the light filtered by the filtering unit 20 is reflected by the reflector 22 to be received by the imaging unit 16. The imaging unit 16 receives the light from the reflector 22 and transmits the received light to the projection lens 18. The projection lens 18 is disposed between the imaging unit 16 and the screen 12, so as to project the light from the imaging unit 16 on the screen 12. In a digital light processing (DLP™) projector, the filtering unit 20 is a color wheel, the imaging unit 16 is a digital micromirror device (DMD), and the reflector 22 is a concave mirror. In a liquid crystal projector, the filtering unit 20 is an optical filter, the reflector 22 is a reflective mirror, and the imaging unit 16 is a liquid crystal panel.

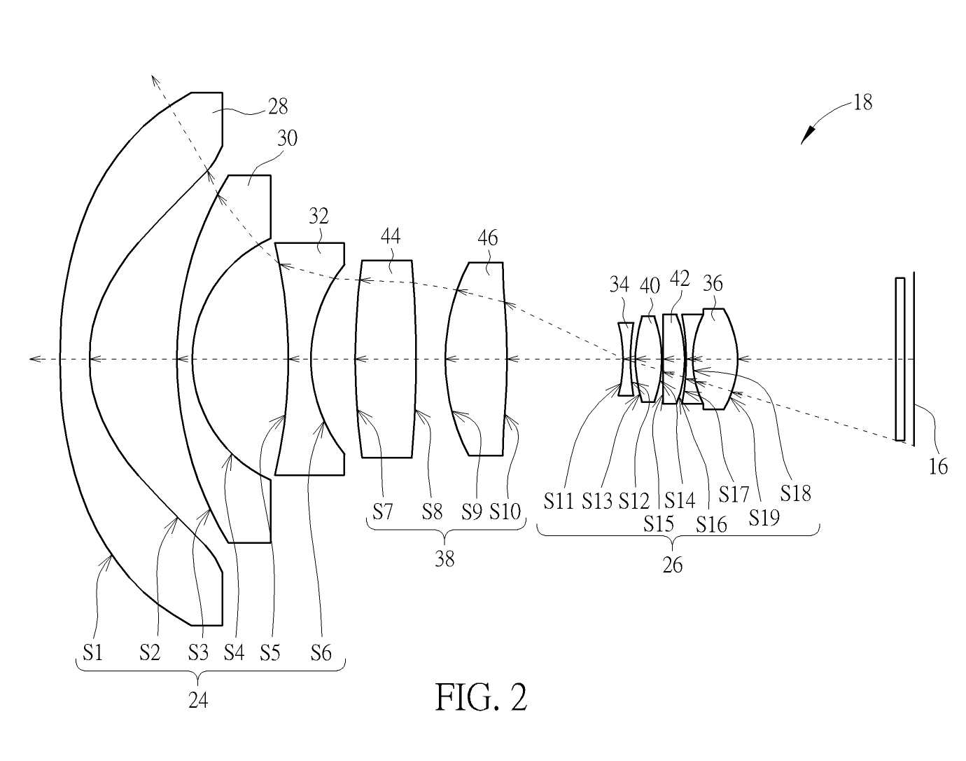

Please refer to FIG. 2. FIG. 2 is a partial diagram of the projection device 10 according to the embodiment of the present invention. The projection lens 18 includes a first lens group 24 and a second lens group 26. The first lens group 24 is adjacent to the screen 12 (which means an object side), and the second lens group 26 is adjacent to the imaging unit 16 (which means an image side). The first lens group 24 has negative diopter and is utilized to diverge the light. The second lens group 26 has positive diopter and is utilized to condense the light. The first lens group 24 includes a first lens 28, a second lens 30 and a third lens 32, and all have the negative diopter. The first lens 28 is an aspheric lens adjacent to the screen 12 (such as the object side), the second lens 30 is located between the first lens 28 and the third lens 32, and the first lens 28 and the second lens 30 can be meniscus lenses.

In the present invention, a focus ratio of the first lens group 24 to the projection lens 18 is constrained within a specific range for balancing the manufacturing cost and structural design of the projection lens 18. For example, an effective focal length of the projection lens 18 represents f, a focal length of the first lens group 24 represents f_{G1}, the effective focal length f preferably ranges from 5 to 7 millimeter (such as 5.0 mm ≦f≦7.0 mm), and the focus ratio of the focal length f_{G1} to the effective focal length f preferably equals 0.75≦|f_{G1}|/f≦1.28.

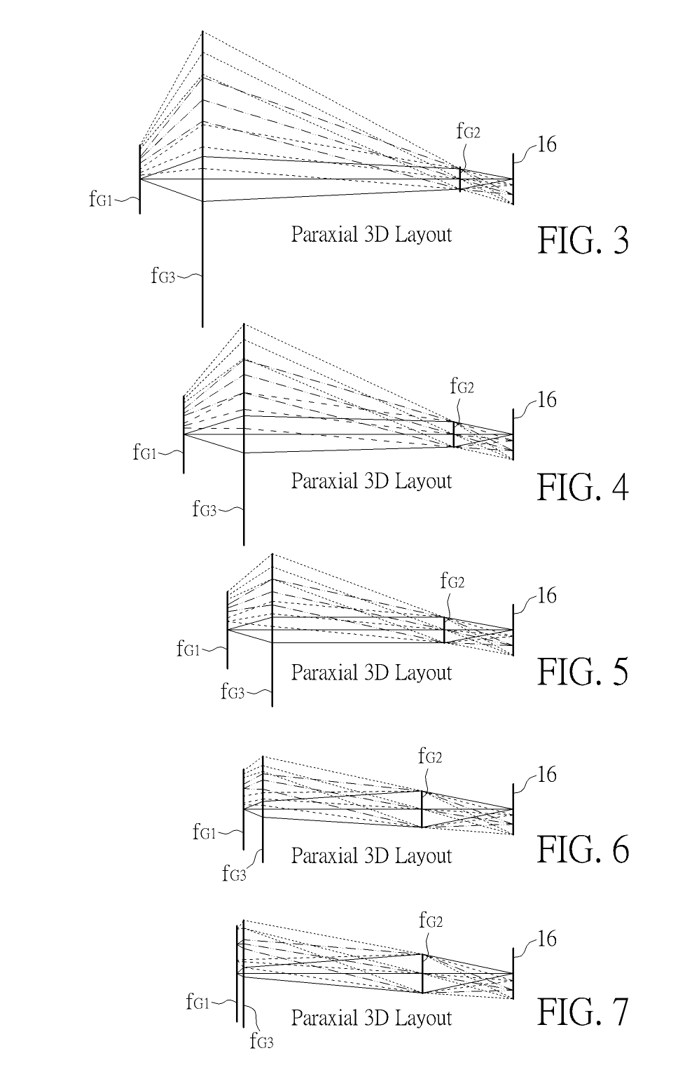

Please refer to FIG. 3 to FIG. 7. FIG. 3 to FIG. 7 respectively are schematic diagrams of the first lens group 24 of the projection lens 18 having different focus length f_{G1} while the effective focal length f, a focal length f_{G2} of the second lens group 26 and a focal length f_{G3} of the third lens group 38 are constant according to the embodiment of the present invention. Table 1 illustrates several situations that the effective focal length f of the projection lens 18 equals 6 mm, the focal lengths f_{G2} and f_{G3} of the second lens group 26 and the third lens group 38 respectively equals 23.027 mm and 22.42 mm, and the focal length f_{G1} of the first lens group 24 is varied and ranges from −4 to −8 mm. A total length and a back focal length f_{bfl} of the projection lens 18 can be analyzed according to different ratios of the focal length f_{G1} to the effective focal length f.

TABLE 1

| | Total length (mm) | | | | |
|---|---|---|---|---|---|
| | 130 | 115 | 94 | 94.06 | 96.517 |
| f (mm) | 6 | 6 | 6 | 6 | 6 |
| f_{G1} (mm) | −4 | −5 | −6 | −7 | −8 |
| f_{G2} (mm) | 23.027 | 23.027 | 23.027 | 23.027 | 23.027 |
| f_{G3} (mm) | 22.42 | 22.42 | 22.42 | 22.42 | 22.42 |
| f_{bfl} (mm) | 17.615 | 20 | 24 | 30.9 | 31.9 |

As shown in FIG. 3, while the foresaid ratio is smaller than the lower limit (namely, the focal length f_{G1} equals −4 mm), the total length of the projection lens 18 is longer, the back focal length f_{bfl} becomes shorter accordingly, and the projection lens 18 is easily interfered with other components of the projection device 10, which increases designing and manufacturing cost of the projection lens 18. As shown in FIG. 7, while the foresaid ratio is larger than the upper limit (i.e., the focal length f_{G1} equals −8 mm), the total length of the projection lens 18 is shorter, the back focal length f_{bfl} becomes longer accordingly and more optical components are applied to control aberration, so that the designing and manufacturing cost of the projection lens 18 is increased, and the lens group 24, 26 which are close to each other are easily damaged by structural interference in zooming process. As shown in FIG. 4 to FIG. 6, the foresaid ratio conforms to 0.75≦|f_{G1}|/f ≦1.28, and the total length and the back focal length f_{bfl} of the projection lens 18 can be controlled within an appropriate range. The back focal length f_{bfl} of the projection lens 18 preferably ranges from 18 to 32 mm (i.e. 18 mm≦f_{bfl}≦32 mm).

In addition, the third lens 32 of the present invention is designed to have greater refractive power. For instance, the focal length of the first lens 28 represents f_{L1}, the focal length of the second lens 30 represents f_{L2}, the focal length of the third lens 32 represent f_{L3}, and a formula of

$$\vert \frac{1}{{f}_{L 1}} + \frac{1}{{f}_{L 2}} \vert > \vert \frac{1}{{f}_{L 3}} \vert$$

is set accordingly. That is, the first lens 28 and the second lens 30 with smaller curvature in surface are easily manufactured, so as to decrease the integral cost of the projection lens 18. The third lens 32 preferably can be a biconcave lens.

The second lens group 26 further includes a fourth lens 34, a fifth lens 36, a sixth lens 40 and a seventh lens 42. The fourth lens 34 preferably may be an aspheric lens made of glass material, to provide heat resistant function. The fifth lens 36 is disposed between the fourth lens 34 and the imaging unit 16. The fifth lens 36 preferably maybe a doublet lens shown in FIG. 2, or maybe a single lens with achromatic function. Application of the fifth lens 36 is designed according to actual demand, and a detailed description is omitted herein for simplicity. The projection lens 18 further includes a third lens group 38 disposed between the first lens group 24 and the second lens group 26. The third lens group 38 is a zooming lens group of the projection lens 18. The third lens group 38 may include a eighth lens 44 and a ninth lens 46, and the lens amount of the third lens group 38 is not limited by the embodiment shown in FIG. 2.

In the present invention, the projection lens 18 has ten lenses composed of two aspheric lenses (such as the first lens 28 and the fourth lens 34) and eight spherical lenses (such as the second lens 30, the third lens 32, the fifth lens 36, the sixth lens 40, the seventh lens 42, the eighth lens 44 and the ninth lens 46). The fifth lens 36 may be the doublet lens combined with two single lenses. Table 2 illustrates preferred parameters of each lens of the projection lens 18. Further, “Distance” in Table 2 represents an interval between the surface in the current row and the surface in the next row.

TABLE 2

| | | | | Refractive | Abbe | Focal |
|---|---|---|---|---|---|---|
| | Sur- | Radius | Distance | index | Number | length |
| Lens | face | (mm) | (mm) | (Nd) | (Vd) | (FL) |
| 28 | S1 | 94 | 3.55 | 1.491668 | 55.3102 | −51.338 |
| | S2 | 19.71 | 10.69791 | | | |
| 30 | S3 | 43.116 | 1.85 | 1.712995 | 53.867056 | −36.766 |
| | S4 | 16.05 | 11.64022 | | | |
| 32 | S5 | −60.1 | 2.7 | 1.834000 | 37.160497 | −16.872 |
| | S6 | 18.89 | 5.380415 | | | |
| 44 | S7 | 83.4 | 7.5 | 1.805181 | 25.425364 | 63.0395 |
| | S8 | −127.13 | 3.453253 | | | |
| 46 | S9 | 25.53 | 7.5 | 1.672700 | 32.099198 | 30.9882 |
| | S10 | −103.84 | 13.68115 | | | |
| 34 | S11 | −25.221 | 0.95 | 1.804300 | 40.481707 | −22.83 |
| | S12 | 70 | 0.478809 | | | |
| 40 | S13 | 16.222 | 3.24 | 1.518229 | 58.902058 | 16.1465 |
| | S14 | −16.222 | 0.15 | | | |
| 42 | S15 | Infinity | 2.6 | 1.487490 | 70.236249 | 34.296 |
| | S16 | −16.77 | 0.15 | | | |
| 36 | S17 | −41.1 | 0.8 | 1.834000 | 37.160497 | −11.044 |
| | S18 | 12.066 | 5.46 | 1.487490 | 70.236249 | 13.328 |
| | S19 | −12.066 | 19.35049 | | | |

In another embodiment of the present invention, the projection lens 18 may be composed of eight lenses. The third lens group 38 may consist of the eighth lens 44 (which means the ninth lens 46 is omitted), and the fifth lens 36 of the second lens group 26 is replaced by an aspheric lens (not shown in figures) accordingly. Therefore, the lens amount of the projection lens 18 of the present invention is not less than eight lenses, and cannot have more than twelve lenses due to the limited inner space of the projection lens 18; it is to say, the lens amount of the projection lens 18 preferably ranges from 8 to 12 lenses.

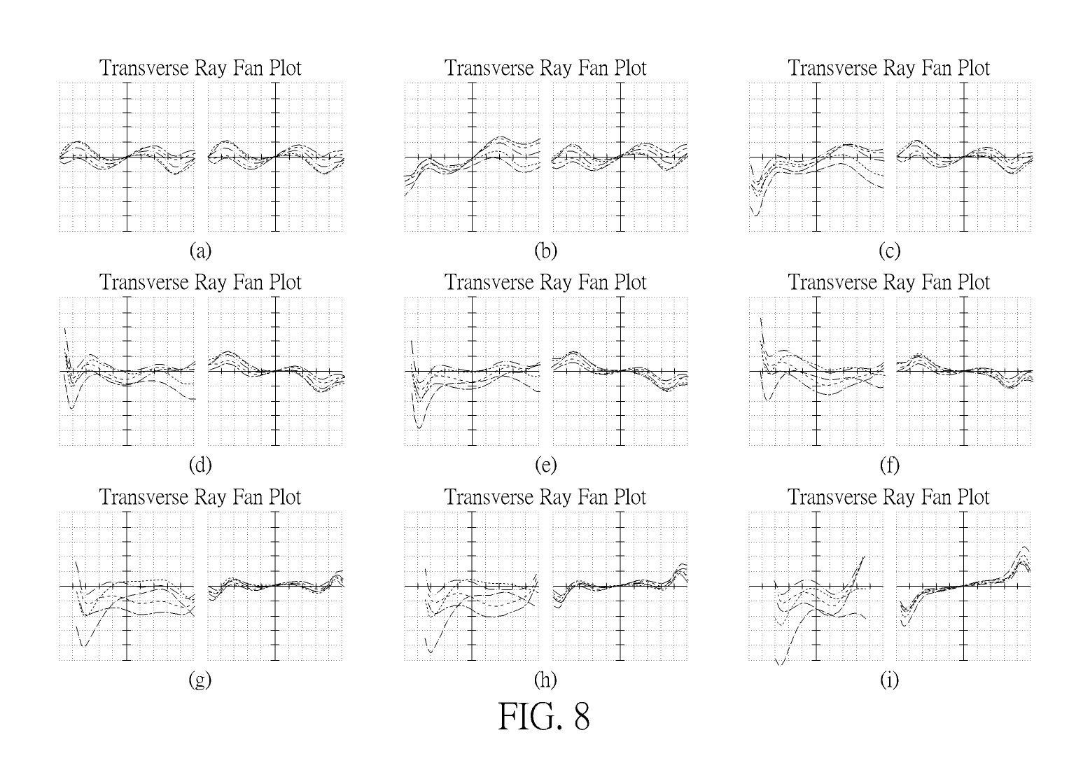

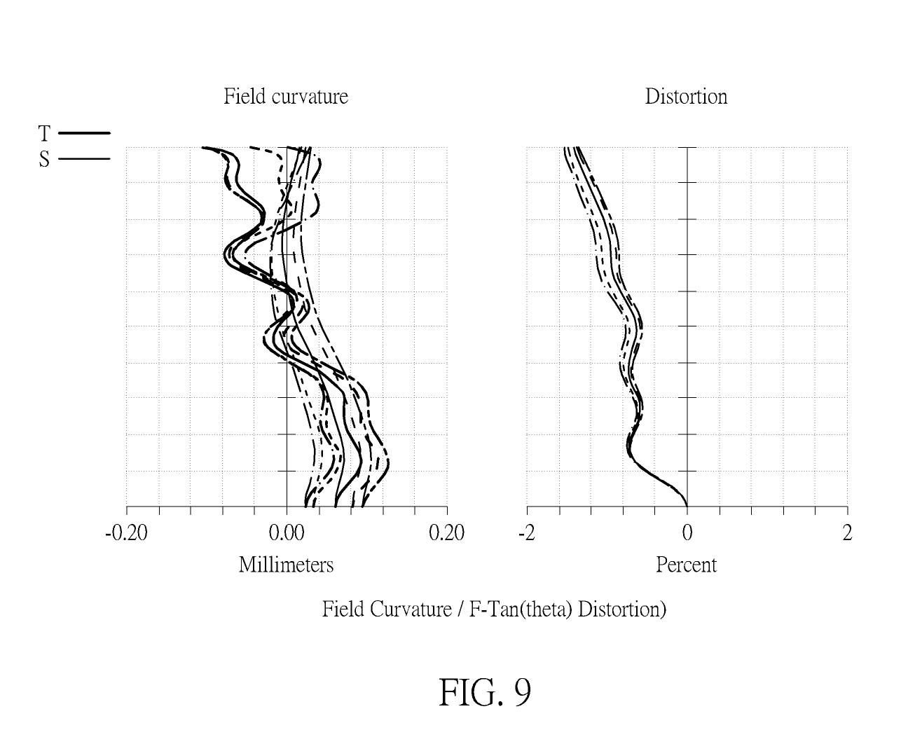

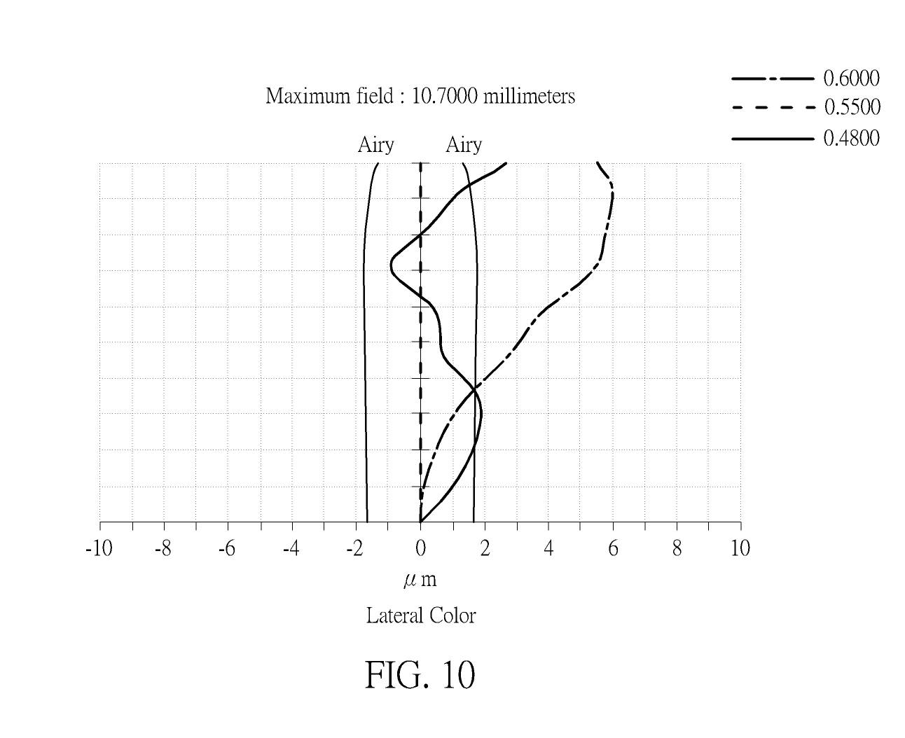

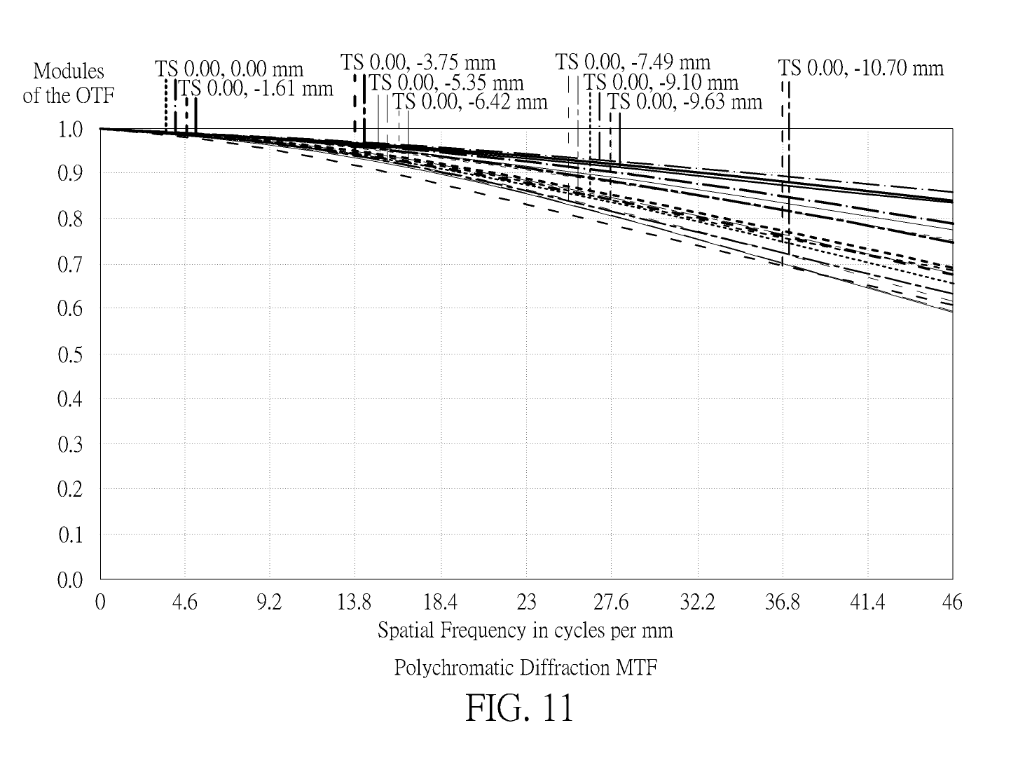

Please refer to FIG. 8 to FIG. 11. FIG. 8 is a simulating diagram of ray aberration of the projection lens 18 according to the embodiment of the present invention. FIG. 9 is a simulating diagram of field curvature and distortion of the projection lens 18 according to the embodiment of the present invention. FIG. 10 is a simulating diagram of lateral color of the projection lens 18 according to the embodiment of the present invention. FIG. 11 is a simulating diagram of modulation transfer function (MTF) of the projection lens 18 according to the embodiment of the present invention. FIGS. 8(a)-8(i) respectively illustrates optical ray aberration simulation of the projection lens 18 of the present invention corresponding to 9 locations on the imaging unit 16. The projection lens 18 can effectively adjust lateral color and defocus, and acquire preferred control over the distortion, the field curvature and the lateral color. According to the modulation transfer function (MTF) shown in FIG. 11, the projection lens 18 of the present invention has good performance of contrast ratio and sharpness.

A conventional short throw projection lens forms obvious aberration on an edge of the image. The present invention designs the non-telecentric projection lens which applies the aspheric lens to be the first lens 28 of the lens group. The present invention utilizes the aspheric lens to correct optical defect such as imaging distortion and chromatic aberration, not only can effectively increase imaging quality of the projection device but also decreases the lens amount of the projection lens to provide advantages of inexpensive cost and easy mass production.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A projection lens, comprising:
a first lens group adjacent to an object side, the first lens group comprising:
a first lens, having negative diopter and being an aspheric lens adjacent to the object side,
a second lens having negative diopter; and
a third lens having negative diopter, the second lens being located between the first lens and the third lens; and
a second lens group adjacent to an image side and having positive diopter;
wherein an effective focal length of the projection lens represents f, a focal length of the first lends group represents f_{G1}, focal length of the first lens, the second lens and the third lens respectively represents f_{L1}, f_{L2} and f_{L3}, and 0.75≦|f_{G1}|/f≦1.28,
$$\vert \frac{1}{{f}_{L 1}} + \frac{1}{{f}_{L 2}} \vert > \vert \frac{1}{{f}_{L 3}} \vert .$$

2. The projection lens of claim 1, wherein the effective focal length of the projection lens f conforms to5.0 mm≦f≦7.0 mm.

3. The projection lens of claim 1, wherein a back focal length of the projection lens represents f_{bfl}, and conforms to 18 mm≦f_{bfl}≦32 mm.

4. The projection lens of claim 1, wherein the projection lens is a non-telecentric system.

5. The projection lens of claim 1, wherein the third lens is a biconcave lens.

6. The projection lens of claim 1, wherein the second lens group comprises a fourth lens and a fifth lens, the fourth lens is an aspheric lens made of glass material, and the fifth lens is a doublet lens located between the fourth lens and the image side.

7. The projection lens of claim 1, further comprising:
a third lens group disposed between the first lens group and the second lens group, the third lens group being a zooming lens group of the projection lens.

8. The projection lens of claim 7, wherein a lens amount of the projection lens ranges from 8 to 12.

9. A projection device of projecting an image on a screen, the projection device comprising:
a light source for emitting light;
an imaging unit for receiving the light; and
a projection lens disposed between the screen and an imaging unit to project the light on the screen, the projection lens comprising:
a first lens group adjacent to the screen, the first lens group comprising:
a first lens, having negative diopter and being an aspheric lens adjacent to the object side,
a second lens having negative diopter; and
a third lens having negative diopter, the second lens being located between the first lens and the third lens; and
a second lens group adjacent to the imaging unit and having positive diopter;
wherein an effective focal length of the projection lens represents f, a focal length of the first lends group represents f_{G1}, focal length of the first lens, the second lens and the third lens respectively represents f_{L1}, f_{L2} and F_{L3}, and 0.75≦|f_{G1}|/f≦1.28,
$$\vert \frac{1}{{f}_{L 1}} + \frac{1}{{f}_{L 2}} \vert > \vert \frac{1}{{f}_{L 3}} \vert .$$

10. The projection device of claim 9, wherein the effective focal length of the projection lens f conforms to 5.0 mm≦f≦7.0 mm.

11. The projection device of claim 9, wherein a back focal length of the projection lens represents f_{bfl}, and conforms to 18 mm≦f_{bfl}≦32 mm.

12. The projection device of claim 9, wherein the projection lens is a non-telecentric system.

13. The projection device of claim 9, wherein the third lens is a biconcave lens.

14. The projection device of claim 9, wherein the second lens group comprises a fourth lens and a fifth lens, the fourth lens is an aspheric lens made of glass material, and the fifth lens is a doublet lens located between the fourth lens and the imaging unit.

15. The projection device of claim 9, wherein the projection lens further comprises a third lens group disposed between the first lens group and the second lens group, and the third lens group is a zooming lens group of the projection lens.

16. The projection device of claim 15, wherein a lens amount of the projection lens ranges from 8 to 12.
